(19) United States
(12) Patent Application Publication
(10) Pub. No.: US 2010/0005018 A1
(43) Pub. Date: Jan. 7, 2010

(54) PEER-TO-PEER LENDING SYSTEM FOR THE PROMOTION OF SOCIAL GOALS

(76) Inventor: Leslie A. Tidwell, Ketchum, ID (US)

Correspondence Address: Huntsman Law Group, PLLC, 4466 Riva Ridge Way, Boise, ID, 83709, US

(21) Appl. No.: 12/166,101

(22) Filed: Jul. 1, 2008

(51) Int. Cl. G06Q 40/00

(52) U.S. Cl. 705/35

(57) ABSTRACT

A system and method for realizing a peer-to-peer lending system directed toward equipment based projects related to an identified social goal. The preferred embodiment contemplates an internet web system that facilitates the funding of pre-approved, small to medium sided “green” energy projects to encourage alternate energy efforts and related environmentally friendly projects. The invention utilizes a number of subsystems not found in prior art peer-to-peer lending systems that facilitate these kinds of projects including, but not limited to, integrating support for secondary loans into the system, allowing the system to use social friendly equipment as collateral for the loans, and reporting carbon credits created by realization of the projects, thus allowing lenders to provide loans to facilitate a specified social goal and measure their effectiveness in furthering a social goal.

This application claims priority from provisional patent No. 61/046,729, filed on Apr. 21, 2008.

### BACKGROUND OF THE INVENTION

Internet based peer-to-peer (“P2P”) lending web sites are a relatively new phenomenon. The existing peer-to-peer lending sites attract a number of different potential lenders and a number of different borrowers and attempt to match lenders and borrowers. Some sites play a role in subsequent loans and manage various aspects of the process; others just serve as “deal makers” and are not involved in the actual funding of loans or in the management of loans.

Such sites generally want to attract large numbers of both lenders and borrowers, and thus the sites tend to be very general and dispassionate as to the exact nature of the underlying loans. Because of their general nature, these systems are not tuned to particular lending paradigms and are often only useful for relatively uncomplicated deals.

Another area of growth on the internet is the promulgation of social network, where individuals can electronically associate with other like minded individuals and exchange ideas and information about common goals and areas of interest. A current limitation of the present social networking systems is that although they facilitate shared thoughts and talk, they rarely promote significant action.

Existing peer-to-peer lending sites are generally content neutral in the sense that lenders are generally interested more in the credit-worthiness of the borrower than the borrower's plans for the loan. In existing systems, the lender's interest in the borrower's use of the loaned money is generally for collateral purposes, focusing on ensuring repayment. However, there is a group of prospective lenders who share the desire to be repaid, but their primary interest, unlike traditional lenders, in not necessarily loan payment or return on investment. The members of such special group of lenders are proponents of a specific social goal. The primary purpose of such lenders is to make loans that will further a social goal, and loan repayment and return of investment may be of secondary importance. Existing peer-to-peer lending systems fail to fully accommodate the special lenders and the potential borrowers who seek financing for projects that would further the social goal.

What is needed is a system that leverages the power of the internet to bring together people with common social interests, and move beyond the talking stage, and facilitate action in the form of funded projects, by bringing together lenders with capital that desire to further a social goal with borrowers who share the same social goal and have a useful skill set, but need funding to implement worthwhile projects to further a common social objective.

Additionally what is needed is the inclusion of an advocacy organization with the lending process, where the advocacy organization, devoted to the promotion of one or more worthy social goal, can integrate its expertise, experience, and philanthropic interests into the lending process.

### SUMMARY OF THE PRESENT INVENTION

The present invention addresses these limitations and provides new and important benefits. Specifically, the invention involves teaching and implementing a system and method for deploying a peer-to-pending internet based lending site focused on furthering specified social goals, common to both potential lenders and borrowers.

In the preferred embodiment, a site is established to promote the social cause of funding “green” projects that are ecologically sound projects that improve the environment directly or indirectly by promoting the design and employment of things like alternate energy systems, and other environmentally friendly projects. Unlike existing dispassionate peer-to-peer lending system, this invention provides features where the passion and social motivation of the participants is captured and exploited to more efficiently achieve real social progress. Unlike social “chat” systems, participants can put their resources—be it capital, skill, or labor, to work to actually design, implement, fund, and execute worthy projects, that do more than just prove a return on investment—these projects will making a real difference in the world by turning talk into action and allowing lenders to participate in a monitored system where they can see what their capital is doing and in some circumstances, be an active participant in the projects they fund.

The present invention integrates expertise, specific to the social goal, into the process primarily by pre-qualifying prospective borrowers. In the preferred embodiment, where alternate-energy projects are favored, the pre-qualification process helps identify state and local government incentive programs that can be integrated into the process, and also directs prospective borrowers to pre-approved retail concerns that can help the borrower scope his or her project, identify appropriate equipment, and prepare a formal bid.

The present invention is particularly suitable for foundation investors because it provides an efficient structure for foundation investors to further a social goal through many individual project loans. Additional, the invention provides for a secondary market for loans to be resold to if a lender wants or needs to get out early from a loan. Typical prior art P2P lending systems limit loan amounts to approximately $25,000. The present invention contemplates a system to provide significantly higher loan amounts so that medium small renewable energy projects could be funded such as $500,000 project to fund a wind turbine to pump irrigation water.

Although the preferred embodiment focuses on the development of “Green” energy projects, the invention is not so limited, and is applicable to other project-oriented social causes. For example, a social concern interested in the promotion of building a certain type of a school, could deploy this invention to deploy a peer-to-peer lending systems to integrate borrowers and lenders with the compatible interests.

### BRIEF DESCRIPTION OF THE DRAWING

FIG. 1 is a flowchart illustrating generally the process a typical prospective borrower would follow using the present invention.

### DETAILED DESCRIPTION OF THE PRESENT INVENTION

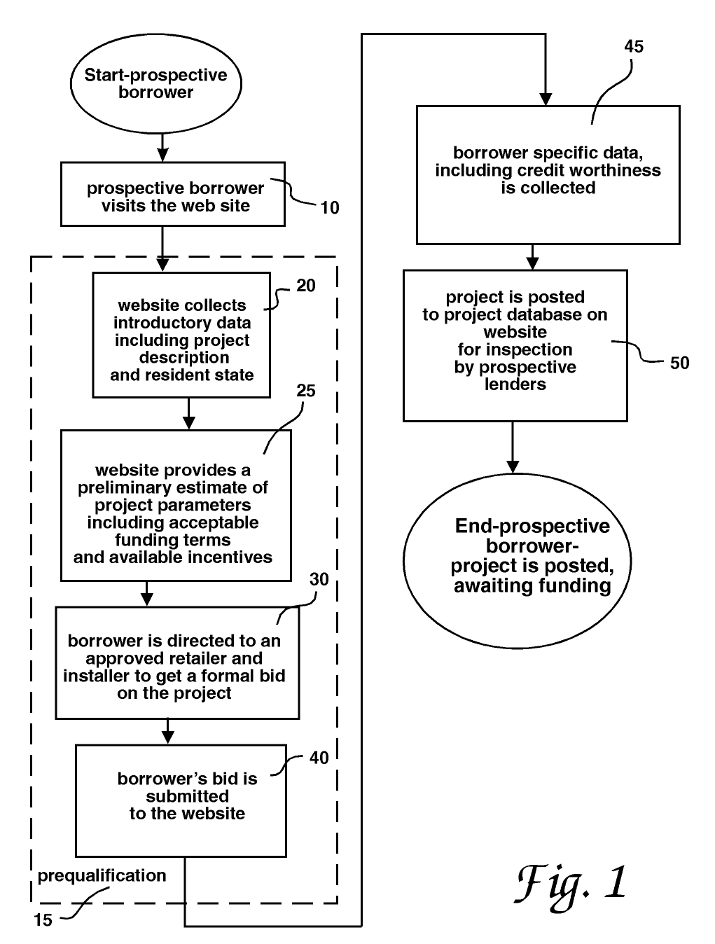

FIG. 1 shows generally the typical process a typical prospective borrower would engage in using the present invention. Referring to FIG. 1, the process starts with a prospective borrower contemplating seeking funding using a website deploying the present invention. The first step 10 is that prospective borrower visits the website. The initial visit would initiate a prequalification process 15, which would include sub steps of collecting introductory data 20, including a description of the contemplated project and, for a U.S. borrower, the borrower's state of residence. Next, the information could then be used by the site to identify state or local incentive programs that could be utilized to help fund the project 25. Based on the preliminary information from the borrower, the site at this point could also disclose proposed funding terms suited for the project. An important benefit of the present invention is that key funding terms, such as the interest rate and repayment terms will generally be much more favorable than that obtained in the open market because the site attracts lenders who, because of their philanthropy, are willing to forego profits and assume more risk than a typical lender to promote the underlying social goal shared by the borrower and lender.

For example, consider such a peer-to-peer lending system based on the social goal of promoting environmentally friendly alternative energy projects. Suppose a prospective borrower is contemplating putting solar panels on the roof of his residence. He would take the step of visiting the appropriate website 10. He or she would input the general description of the contemplated project—putting solar panels on a residential roof The system typically would then query the prospective borrower 20, through the web site, asking questions such as “What state do you live in?” and “Do you own your own home?” and “What is your annual electrical bill?” The website, being associated with an organization with expertise in these kinds of projects, could then respond with a preliminary assessment 25 such as “Your savings will be approximately $w and you may post your project on this website for funding at a x % interest rate for y years with an approximate monthly patent of $z.

The next step in the borrower pre-qualification process 15 would be to direct the borrower to an approved solar retailer and installer 30 to get the project sized and quoted. The borrower need not necessarily use the recommended installer, but in order to protect the overall integrity of the system, any installer would have to register with the site and be pre-approved. Once the project has been successfully sized, and a bid quoted, the project is the considered to be prequalified. After prequalification, the borrower will have prequalification credentials, including the authorized bid, which then may be submitted to the system 40. At this point, the system may also engage in traditional borrower prequalification such as credit-worthiness checks 45. Using the website, the project is then posted to a database of projects 50 seeking funding, where prospective lenders can inspect the various projects and offer funding for projects of interest.

In addition to the basic functionality described above, the present invention contemplates the integration of combinations one or more of the following subsystems:

### Pre-Qualification of Projects Before Posting

The projects can be qualified not only on traditional financial criteria, but on the basis of desirable goals, and can thus limit participants to only those interested in advancing the common social goal such as “green” projects.

The preferred embodiment of this invention contemplates a project model where the projects involve the purchase and installation of products, either new or off the shelf For example, someone might desire to build a “wind farm” on pre-owned land and would require capital for the purchase of relatively expensive wind turbine technology. The project could be evaluated on the basis of its “green” benefits as well as on the basis of the credit worthiness of the borrower.

### Establishment of “Reputable” Installers

By focusing on specific areas of desirable social goals, the system can help identify and reputationally rate sellers of equipment related to the goals of the site, based on the premise that the site will have numerous similar projects involving the same or similar equipment.

### Matching with State and Federal Project Incentives

For certain social goals, there are often government incentive programs, as well as private foundations and other private sources available for projects that meet certain criteria. This system can include such programs and coordinate them with other private lenders, providing both matching services, and providing funding opportunities consisting of a blend of incentive programs with private lenders to fund worthy projects that otherwise would not find appropriate funding.

### Secondary Market for Executed Loans

Since the contemplated social projects often require capital to be amortized over potentially large periods of times, the invention contemplates facilitating a secondary loan market, where initial lenders, particularly ones, would have the opportunity to cash out before project completion by selling their loans to other lenders better suited to long term investing.

### Securitization and Perfection of Security Interest In Financed Project Equipment

Unlike the prior art systems that generally either deal with unsecured loans, or loans guaranteed by third party guarantors, this system contemplates a peer-to-peer lending system where the loans are secured, at least in part, by the system, using the purchased “socially friendly” equipment as collateral. For example, in the U.S., Article 9 purchase money security interests (PMSI) can be used to secure the loans and the system can help by managing and automating the filing of the required liens and related paperwork to properly perfect the liens.

### Online Inbound Monthly Project Statements by Borrowers and Outbound to Lenders

Many existing social lending systems provide financial statements by borrowers or even lenders in some cases. This system contemplates statements that report on the progress of the social goal as well as progress on project construction and related financial matters so that lenders in particular can monitor the effect of their loan and determine if their social concerns are being realized.

### Online Inbound Annual Carbon Savings Statements by Borrowers and Outbound to Lenders

Given the relatively new concept of “carbon credits” and “carbon savings”, this system contemplates both reporting each, and also facilitating “carbon credit” transactions, essentially providing a real-world marketplace to deal in a “carbon credit” virtual economy. It is contemplated that as carbon credits are thus managed, their real-world value will increase, and both lenders and borrowers will be further motivated to participate in projects that leave smaller carbon footprints and encourage more interest in “green” projects.

### Construction Draw Model of Milestone Fund Distributions Directly to Installers

The present inventions contemplates including “milestone” funds distributions management by the system analogous to construction loans, where loan distributions are distributed piecemeal by the system in an orderly to discourage misuse of loan proceeds particularly by inexperienced borrowers.

### Disintermediation

“Disintermediation” generally refers to improving the efficiency of processes by eliminating the need for “middle men”. Peer-to-peer lending systems generally have this benefit, but the present invention contemplates introducing such efficiencies at a much larger scale, in new and unobvious ways, and the principle is applied in conjunction with some of the other limitation described above. For example, in the process of establishing reputable sellers, smaller sellers in remote locations may have an opportunity to compete, thus allowing market forces to provide lower cost and/or better quality equipment.

The above descriptions are provided for illustration not limitation. As one skilled in the art will appreciate, the invention is useful for a number of different types of projects consistent with a number of different social goals not explicitly described above. For example, social goals such as building schools or libraries, providing disaster relief, feeding or clothing the hungry or needy, developing energy-efficient automobiles, and funding specific medical research/cure efforts could be pursued using the invention taught herein. Thus the invention should not be limited by the description above, but should be limited only by the claims as set forth below.

I claim:

1. A method for allowing a prospective borrower to bid for a project-specific loan using a website in a wide-area networking environment, wherein the project is related to the promotion of an identified social goal comprising the steps of:
step 1: prequalifying the project by determining prequalification project parameters, the project parameters further include project capital equipment, funding terms, the funding terms further include a loan rate, a repayment installment plan, and the identification of available financial incentives based on the geographic address of the prospective buyer,
step 2: optionally-further prequalifying the project by determining prequalification parameters of the borrower including parameters that reflect buyer credit worthiness,
step 3: posting the project, including the project parameters, to a database of projects using the website, for inspection by prospective lenders.

2. The method of claim 1, wherein the method further includes the following steps between step 1 and step 2:
step 1A: the website collecting introductory data from the prospective borrower, including a project description and the geographical address of the prospective borrower,
step 1B: the website identifying zero or more available financial incentives based on the geographical address of the prospective buyer, and the identified social goal,
step 1C: the website directing the prospective buyer to at least one approved retailer, wherein the approved retailer identifies capital equipment required for the project and further provides a bid to purchase and install the identified capital equipment, wherein the bid is included in the project parameters.

3. The method of claim 2, wherein the prequalification parameters of step 1 are set by an oversite organization.

4. The method of claim 1, wherein the prequalification parameters of step 1 are set by an oversite organization.

5. A system for allowing a prospective borrower to bid for a project-specific loan in a wide-area networking environment, wherein the project is related to the promotion of an identified social goal, wherein the project further requires the acquisition of equipment related to the identified social goal comprising:
a website, wherein prospective prequalified borrowers add projects needing funding to a list maintained by said website, wherein the projects are consistent with said social goal. wherein at least one lender uses said website to review said list and identify at least one project from said list for which said lender provides a loan to enable the prospective borrower to purchase said equipment related to said social goal.

6. The system of claim 5, further comprising a system for providing a secondary market for said loan, wherein the website further including a list of prospective secondary lenders to enable said lender to sell said loan to a secondary lender identified in said list of secondary lenders.

7. The system of claim 6, further comprising a system wherein said loan is at least partially secured with said equipment related to said social goal, wherein said equipment serves as collateral for the loan.

8. The system of claim 7, further comprising a reporting system wherein carbon credits that accrue because of realization of said project are reported.

9. The system of claim 8 further comprising:
a list of milestones associated with the implementation of said project,
a system for distributing loans, wherein loan proceeds are distributed in a plurality of payments wherein each payment coincides with at least one milestone.

10. The system of claim 7 further comprising:
a list of milestones associated with the implementation of said project,
a system for distributing loans, wherein loan proceeds are distributed in a plurality of payments wherein each payment coincides with at least one milestone.

11. The system of claim 6, further comprising a reporting system wherein carbon credits that accrue because of realization of said project are reported.

12. The system of claim 11 further comprising:
a list of milestones associated with the implementation of said project,
a system for distributing loans, wherein loan proceeds are distributed in a plurality of payments wherein each payment coincides with at least one milestone.

13. The system of claim 6 further comprising:
a list of milestones associated with the implementation of said project,
a system for distributing loans, wherein loan proceeds are distributed in a plurality of payments wherein each payment coincides with at least one milestone.

14. The system of claim 5, further comprising a system wherein said loan is at least partially secured with said equipment related to said social goal, wherein said equipment serves as collateral for the loan.

15. The system of claim 14, further comprising a reporting system wherein carbon credits that accrue because of realization of said project are reported.

16. The system of claim 15 further comprising:
a list of milestones associated with the implementation of said project,
a system for distributing loans, wherein loan proceeds are distributed in a plurality of payments wherein each payment coincides with at least one milestone.

17. The system of claim 14 further comprising:
a list of milestones associated with the implementation of said project,
a system for distributing loans, wherein loan proceeds are distributed in a plurality of payments wherein each payment coincides with at least one milestone.

18. The system of claim 5, further comprising a reporting system wherein carbon credits that accrue because of realization of said project are reported.

19. The system of claim 18 further comprising:
a list of milestones associated with the implementation of said project,
a system for distributing loans, wherein loan proceeds are distributed in a plurality of payments wherein each payment coincides with at least one milestone.

20. The system of claim 5 further comprising:
a list of milestones associated with the implementation of said project,
a system for distributing loans, wherein loan proceeds are distributed in a plurality of payments wherein each payment coincides with at least one milestone.

21. A method for allowing a prospective borrower to bid for a project-specific loan using a website in a wide-area networking environment, wherein the project is related to the promotion of an identified social goal comprising the steps of:
step 1: prequalifying the project by determining prequalification project parameters, the project parameters further include project capital equipment, funding terms, the funding terms further include a loan rate, a repayment installment plan, and the identification of available financial incentives based on the geographic address of the prospective buyer,
step 2: posting the project, including the project parameters, to a database of projects using the website, for inspection by prospective lenders.

22. The method of claim 21, wherein the method further includes the following steps between step 1 and step 2:
step 1A: the website collecting introductory data from the prospective borrower, including a project description and the geographical address of the prospective borrower,
step 1B: the website identifying zero or more available financial incentives based on the geographical address of the prospective buyer, and the identified social goal,
step 1C: the website directing the prospective buyer to at least one approved retailer, wherein the approved retailer identifies capital equipment required for
the project and further provides a bid to purchase and install the identified capital equipment, wherein the bid is included in the project parameters.

23. The method of claim 22, wherein the prequalification parameters of step 1 are set by an oversite organization.

24. The method of claim 21, wherein the prequalification parameters of step 1 are set by an oversite organization.
